(19) United States
(12) Patent Application Publication
(10) Pub. No.: US 2025/0338257 A1
(43) Pub. Date: Oct. 30, 2025

(54) A METHOD OF DUAL SUBSCRIBER IDENTITY MODULE (SIM)-DUAL ACTIVE (DSDA) USER EQUIPMENT (UE) FLEXIBLE TRANSMISSION RESOURCE-SHARING MODE SWITCHING AND UPLINK TRANSMISSION PROTECTION

(71) Applicant: QUALCOMM Incorporated, San Diego, CA (US)

(72) Inventors: Qingxin Chen, San Diego, CA (US); Reza Shahidi, La Jolla, CA (US); Ling Xie, Beijing (CN); Cheol Hee Park, San Diego, CA (US); Francis Ming-Meng Ngai, Louisville, CO (US); Arvind Vardarajan Santhanam, San Diego, CA (US); Shailesh Maheshwari, San Diego, CA (US); Rishav Rej, Pleasanton, CA (US); Krishna Chaitanya Mukkera, San Diego, CA (US); Peng Wu, Shanghai (CN); Zhanyi Liu, Beijing (CN)

(21) Appl. No.: 18/840,695

(22) PCT Filed: Apr. 22, 2022
(86) PCT No.: PCT/CN2022/088422

§ 371 Date: Aug. 22, 2024

(51) Int. Cl. H04W 72/02; H04W 72/21; H04W 72/51; H04W 88/06

(52) U.S. Cl. CPC H04W 72/02; H04W 72/21; H04W 72/51; H04W 88/06

(57) ABSTRACT

Systems, methods, and devices for wireless communication that support mechanisms for flexible switching between different resource-sharing configurations of a multi-subscriber identity module (SIM) communications device. A user equipment (UE) configured for multi-SIM communications including a first subscription and a second subscription operates in a concurrent communication mode. The UE is configured with a plurality of resource-sharing configurations for sharing a set of resources between the first subscription and the second subscription during the concurrent communication mode. The UE determines whether one or more switching conditions are present with respect to the concurrent communication mode, selects a resource-sharing configuration of the plurality of resource-sharing configurations based on a determination that the one or more switching conditions are present, and transmitting data over at least one of the first subscription or the second subscription based on the selected resource-sharing configuration.

### CROSS-REFERENCE TO RELATED APPLICATIONS

This application claims the benefit of International Patent Application No. PCT/CN2022/088422, entitled, “A METHOD OF DUAL SUBSCRIBER IDENTITY MODULE (SIM)-DUAL ACTIVE (DSDA) USER EQUIPMENT (UE) FLEXIBLE TRANSMISSION RESOURCE-SHARING MODE SWITCHING AND UPLINK TRANSMISSION PROTECTION,” filed on Apr. 22, 2022, which is expressly incorporated by reference herein in its entirety.

### TECHNICAL FIELD

Aspects of the present disclosure relate generally to wireless communication systems, and more particularly, to mechanisms for managing sharing of transmission chains between multiple subscriptions of a multi-subscriber identity module (SIM) device.

### Introduction

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication performed by a user equipment (UE) includes operating in a concurrent communication mode. The UE is configured for multi-subscriber identity module (SIM) communications including a first subscription and a second subscription, and is configured with a plurality of resource-sharing configurations for sharing a set of resources available to the UE between the first subscription and the second subscription during the concurrent communication mode. The method also includes determining, by the UE, whether one or more switching conditions are present with respect to the concurrent communication mode, selecting a resource-sharing configuration of the plurality of resource-sharing configurations based on a determination that the one or more switching conditions are present, and transmitting data over at least one of the first subscription or the second subscription based on the selected resource-sharing configuration.

In an additional aspect of the disclosure, a UE includes at least one processor and a memory coupled to the at least one processor. The at least one processor stores processor-readable code that, when executed by the at least one processor, is configured to perform operations including operating in a concurrent communication mode. The UE is configured for multi-SIM communications including a first subscription and a second subscription, and is configured with a plurality of resource-sharing configurations for sharing a set of resources available to the UE between the first subscription and the second subscription during the concurrent communication mode. The operations also include determining whether one or more switching conditions are present with respect to the concurrent communication mode, selecting a resource-sharing configuration of the plurality of resource-sharing configurations based on a determination that the one or more switching conditions are present, and transmitting data over at least one of the first subscription or the second subscription based on the selected resource-sharing configuration.

In an additional aspect of the disclosure, a non-transitory computer-readable medium stores instructions that, when executed by a processor, cause the processor to perform operations. The operations include operating, by a UE, in a concurrent communication mode. The UE is configured for multi-SIM communications including a first subscription and a second subscription, and is configured with a plurality of resource-sharing configurations for sharing a set of resources available to the UE between the first subscription and the second subscription during the concurrent communication mode. The operations also include determining whether one or more switching conditions are present with respect to the concurrent communication mode, selecting a resource-sharing configuration of the plurality of resource-sharing configurations based on a determination that the one or more switching conditions are present, and transmitting data over at least one of the first subscription or the second subscription based on the selected resource-sharing configuration.

In an additional aspect of the disclosure, an apparatus includes means for operating, by a UE, in a concurrent communication mode. The UE is configured for multi-SIM communications including a first subscription and a second subscription, and is configured with a plurality of resource-sharing configurations for sharing a set of resources available to the UE between the first subscription and the second subscription during the concurrent communication mode. The apparatus also includes means for determining whether one or more switching conditions are present with respect to the concurrent communication mode, means for selecting a resource-sharing configuration of the plurality of resource-sharing configurations based on a determination that the one or more switching conditions are present, and means for transmitting data over at least one of the first subscription or the second subscription based on the selected resource-sharing configuration.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a diagram illustrating an example of wireless communication system that supports flexible switching between different resource-sharing configurations of a multi-subscriber identity module (SIM) communications device in accordance with aspects of the present disclosure.

FIG. 4 is a block diagram of an example wireless communications system that supports mechanisms for flexible switching between different resource-sharing configurations of a multi-SIM communications device in a wireless communication system according to one or more aspects of the present disclosure.

FIG. 5 is a flow diagram illustrating an example of a wireless communication implementing flexible switching between different resource-sharing configurations of a multi-SIM communications device in a wireless communication system according to one or more aspects of the present disclosure.

FIG. 6 is a flow diagram illustrating an example process that mechanisms for flexible switching between different resource-sharing configurations of a multi-SIM communications device according to one or more aspects.

FIG. 7 is a block diagram of an example UE that supports mechanisms for flexible switching between different resource-sharing configurations of a multi-SIM communications device according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS, LTE, and NR are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜ 10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements, etc. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, aggregated or dis-aggregated deployments, end-user devices, etc. of varying sizes, shapes, and constitution.

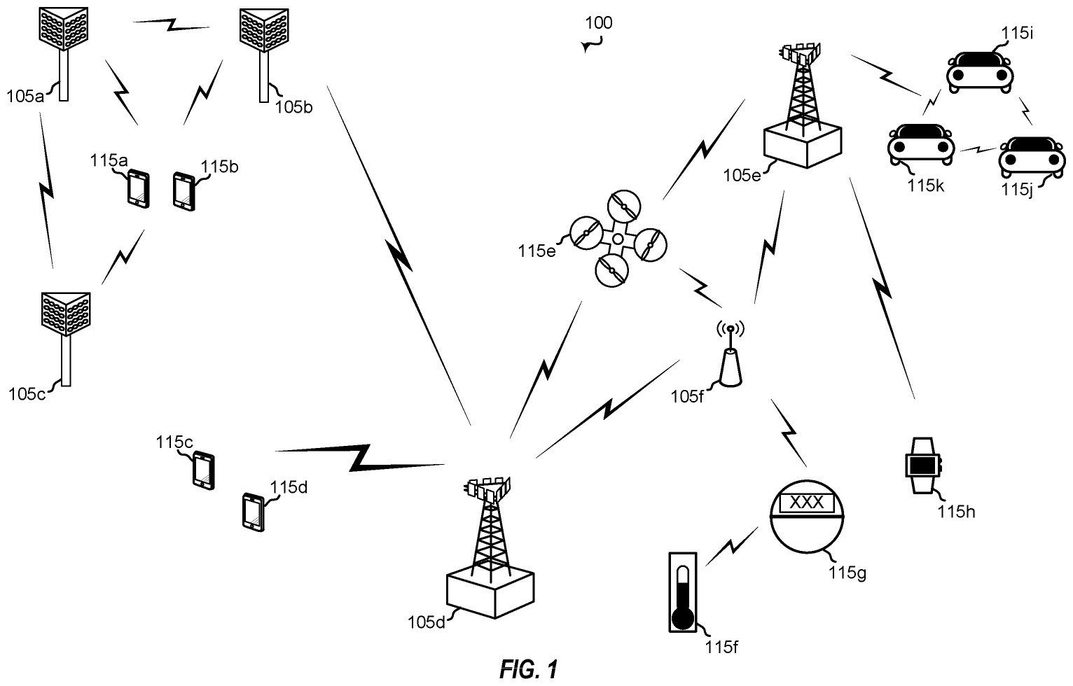

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with one or more UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

In aspects a network entity, network node, network equipment, mobility element of wireless network 100, etc., may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC, etc.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water meter, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

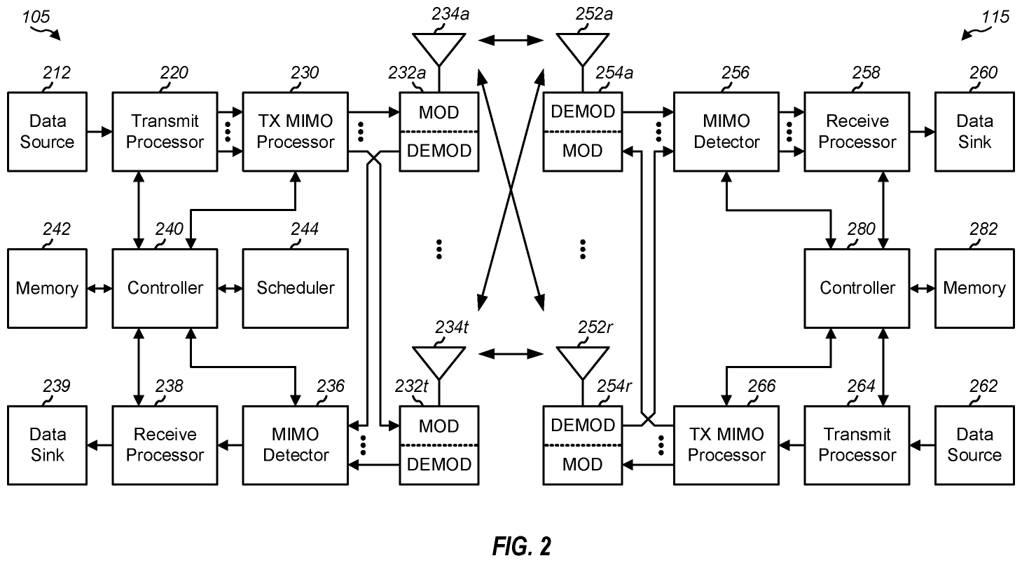

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

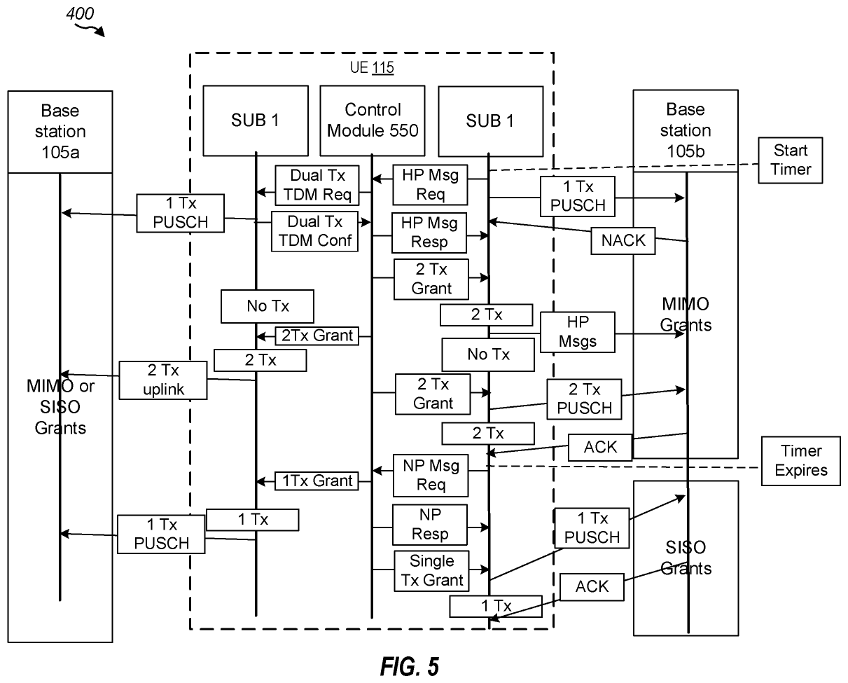

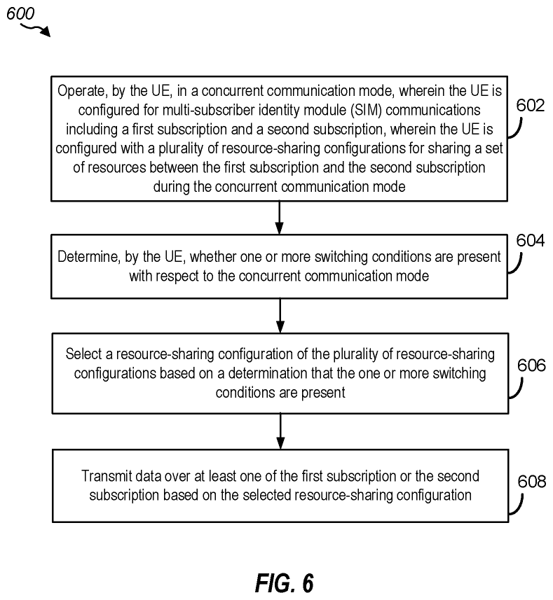

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 5 AND 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Current implementations of wireless communication systems support UEs of various capabilities. In particular, some UEs may be configured to support multi-subscriber identity module (SIM) operations. In multi-SIM operations, a UE may be configured with more than one SIM card and may be capable of operating in radio resource configuration (RRC) connected mode with more than one network entity (e.g., more than one base station). In this manner, the UE may have two active subscriptions, each subscription with each of the one or more network entity. For example, a UE may be configured with two SIMs, and in this case the UE may be capable of operating in RRC connected mode concurrently with two network entities, and each network entity may be associated with a different operator. In implementations, the concurrent operations of a UE to operate in RRC connected mode with two network entities concurrently may be referred to as dual SIM/dual active (DSDA) mode. As such, in DSDA mode, two SIMs of a UE may be concurrently in connected mode with transmissions active with two different network entities.

In DSDA mode, concurrent transmission (Tx) and reception (Rx) may be required to support the two subscriptions in DSDA. In this manner, a UE in DSDA mode may concurrently transmit and/or receive over the two subscriptions. Challenges may arise as Tx resources (e.g., Tx radio frequency (RF) resources, such as Tx chains) and/or Rx resources (e.g., Rx RF resources, such as Rx chains) supported by each subscription may vary. In a typical example, each subscription may support one or two Tx chains on the uplink and two or four Rx chains on the downlink. In order to support concurrent Tx and Rx in DSDA mode, a UE may be configured to manage its resources so that the two subscriptions are able to transmit and/or receive concurrently. The resource management in DSDA mode may include independent resources, or sharing resources.

Independent resources may be configured to provide an independent set of resources to each of the two subscriptions. In this manner, each subscription may make use of its allocated resources without consideration as to the other subscription or its resources. For example, the UE may be configured with two Tx chains, and in this case one Tx chain may be assigned to the first subscription and the other Tx chain may be assigned to the second subscription. However, using independent resources for DSDA mode increases the hardware costs, as each subscription is assigned an exclusive set of resources. Additionally, for uplink transmissions, the UE's Tx power consumption may be limited, and more Tx chains may increase the power consumption.

In contrast to independent resources, DSDA mode may be implemented by using resource-sharing, in which the UE's resources are shared between the two subscriptions. In resource-sharing, the same RF resources of the UE may be shared between the two subscription. For example, the UE may have a limited number of RF chains (e.g., Tx and/or Rx chains). The RF chains may be shared between the two subscriptions in order to enable DSDA mode. By sharing RF resources during DSDA concurrency, each subscription may hold less Tx or Rx chains or share Tx/Rx chains in a multiplexed (e.g., time division multiplex (TDM)) way. The RF resource-sharing between the multiple SIMs may be accomplished in different ways, using different RF resource-sharing configurations.

Various aspects of the present disclosure relate to techniques that provide mechanisms for flexible switching between different resource-sharing configurations of a multi-SIM communications device. In aspects, a UE may be configured with multiple SIMs and a limited set of resources (e.g., RF resources, such as Tx and/or Rx chains). Within the total resource limitation of the UE, various resource-sharing configurations may be possible to enable the UE to share the limited resources between different SIM subscriptions during concurrency operations (e.g., when operating with more than one SIM subscription in connected mode, such as RRC connected mode). Aspects of the present disclosure provide mechanisms to enable the UE to switch between different RF resource-sharing configurations based on various switching conditions. In aspects, the UE may determine whether one or more of the various switching conditions are present, and may determine an RF resource-configuration to select or to switch to, based on the presence of the one or more switching conditions. In aspects, the switching conditions may include a grant type provided to one or more of the multiple subscriptions, a priority of the service being performed by the different subscriptions, a procedure being performed by the different subscriptions, a change in the resources available to the UE, etc.

In aspects, a UE may be enabled to switch from a first resource-sharing configuration to a second resource-sharing configuration based on a capability update by one or more of the subscriptions. For example, each of the subscriptions may be configured to employ a signaling-based capability update and/or an autonomous capability update to trigger the switching from the first resource-sharing configuration to the second resource-sharing configuration. For example, in signaling-based capability update, the UE may transmit, over the first subscription, a message including assistance information to a network entity, and the assistance information may include a transmission capabilities or preferences (e.g., 1L, 2L, etc.) for transmission over the first subscription. In an example of autonomous capability update, the UE may lower a transmission power of one or more reference signals (e.g., a sounding reference signal (SRS) and/or demodulation reference signal (DMRS) in one or more of the transmission ports available to the UE in order to trigger an uplink scheduling from the network entity that includes a lesser or higher number of layers, accordingly, or may the UE may report a fake non-zero buffer status report (BSR) to request more PUSCH transmissions in order to accelerate a scheduling convergence from MIMO to single input, single output (SISO).

It is noted that although the present description focuses on operations of multi-SIM devices, the functionality of aspects may also be applicable to operations of devices with multiple radio access technologies (RAT). In this case, a UE may be configured to operate in connected mode with more than one base station operating with different RATs. As such, the description herein of multi-SIM operations should be understood to be for illustrative purposes and not intended to be limiting in any way.

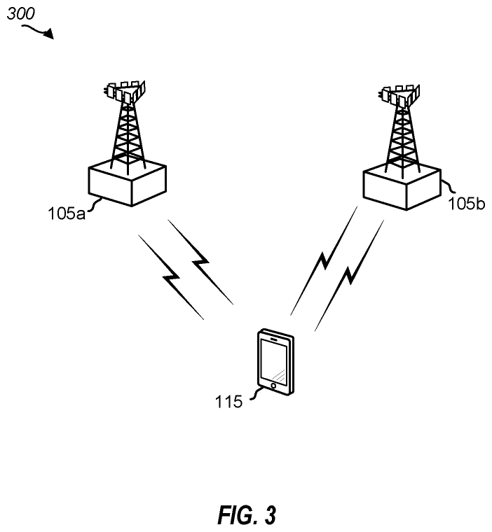

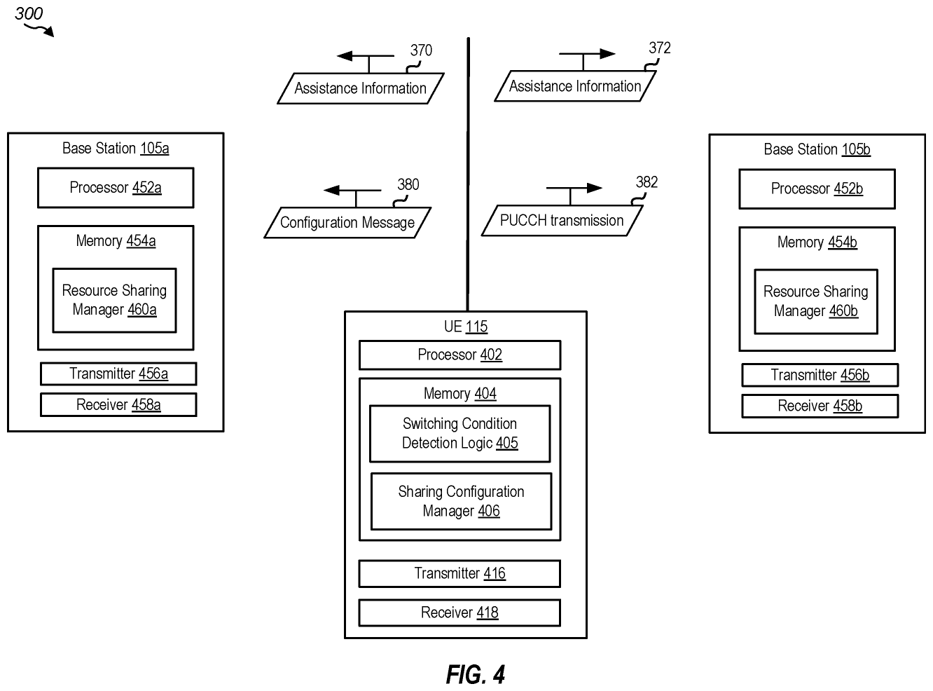

FIG. 3 is a diagram illustrating an example of wireless communication system 300 that supports flexible switching between different resource-sharing configurations of a multi-SIM communications device in accordance with aspects of the present disclosure. In some examples, wireless communications system 300 may implement aspects of wireless network 100 described in FIGS. 1 and 2, and network 400 described in FIG. 4. Wireless communications system 300 includes UE 115 and base stations 105a and 105b. Although one UE 115 and two base stations 105a and 105b are illustrated, in some implementations, wireless communications system 300 may generally include multiple UEs 115, and may include more than two base stations 105.

In aspects, UE 115 may be configured for multi-SIM communications. As such, UE 115 may be configured to subscribe to base station 105a and base station 105b each using a different SIM. Furthermore, UE 115 may be configured to operate in DSDA mode, and in which case both subscriptions of UE 115 may be in connected mode (e.g., RRC connected mode) with each of base station 105a and base station 105b. During this concurrency, UE 115 may communication with both base station 105a and base station 105b via the respective subscription.

It should be understood that the description herein with respect to a multi-SIM communication between one UE and two subscriptions is merely for illustrative purposes and should not be construed as limiting in any way. As such, a multi-SIM communication scheme may include more than two subscriptions and the techniques herein described may be equally applicable in such a situation.

As noted above, DSDA mode may be implemented by using resource-sharing, in which the UE's resources (e.g., Tx and/or RX chains available to the UE) may be shared between the two subscriptions, and which may be implemented in different ways, using different RF resource-sharing configurations. Table 1 below illustrates various RF resource-sharing configurations based on the number of available Tx chains. It is noted that Table 1 is described in terms of sharing of Tx chains, but the same functionality may apply to the sharing of Rx chains.

TABLE 1
RF resource-sharing configurations in DSDA mode

| Number | | | | |
|---|---|---|---|---|
| of Tx | Sharing | | | |
| chains | Configuration | SUB1 | SUB2 | Illustration |
| 1 | Single Tx sharing | 1 Tx 0 Tx | 0 Tx 1 Tx | 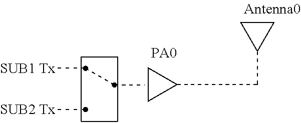 |
| 2 | Single Tx full concurrency | 1 Tx | 1 Tx | 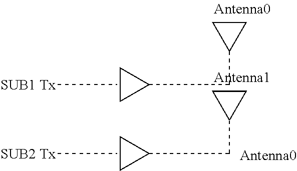 |
| | Dual Tx TDM (Timing Division Multiple xing) | 2 Tx 0 Tx | 0 Tx 2 Tx | 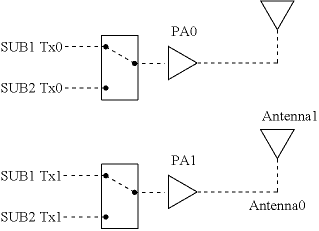 |
| 3 | Dual Tx sharing | 2 Tx 1 Tx | 1 Tx 2 Tx | 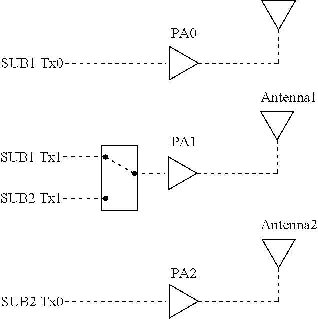 |
| 4 | Dual Tx full concurrency | 2 Tx | 2 Tx | 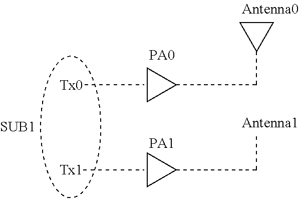 |
| | | | | 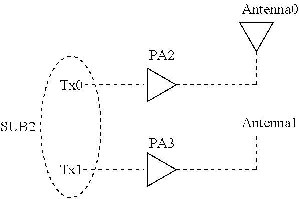 |

As can be seen in Table 1 above, the RF resources of a UE may be shared between the multiple subscriptions of a UE using different configurations, depending on the number of RF chains available to the UE. For example, for a UE configured with a single Tx chain, a single Tx sharing configuration may be used. In the single Tx sharing configuration, each of the subscriptions may use the single Tx chain at a time, in a TDM manner. For example, the single Tx chain may be allocated to one of the subscriptions, and in this case the other subscription may not be allocated any RF resources during that time. During allocation of the Tx chain to one of the subscription, the other subscription may not be able to use the Tx chain to transmit, or the subscription may be blank.

In another example, the UE may be configured with two Tx chains. In this case, more than one resource-sharing configurations may be possible. For example, a single Tx full concurrency configuration may be used, or a dual Tx TDM configuration may be used. In a single Tx full concurrency, each of the subscriptions may be allocated one of the two Tx chains so that concurrent transmissions from both of the subscriptions may be possible, and in this case no subscription may be blank. In the dual Tx TDM configuration, both Tx chains may be allocated to a first subscription, and in this case the second subscription is allocated no RF resources, such that the first subscription is able to transmit using both Tx chains (e.g., the first Tx chain may be granted a MIMO uplink grant using two layers), but the second layer may not be able to transmit during that time.

In still another example, the UE may be configured with three Tx chains. In this case, a dual Tx sharing configuration may be used. In a dual Tx sharing configuration, at least one Tx chain may be allocated to each of the subscriptions, such that all subscriptions may transmit concurrently. In this configuration, the Tx chains may be shared between the subscriptions such that one subscription may be allocated one Tx chain, and the other subscription may be allocated the other two Tx chain enabling the other subscription to transmit with more than one Tx chain (e.g., when receiving a MIMO uplink grant on the other subscription).

In yet another example, the UE may be configured with four Tx chains. In this case, a dual Tx full concurrency configuration may be used. In a dual Tx full concurrency configuration, each of the subscriptions may be allocated two of the four Tx chains so that each subscriptions may transmit with up to 2 layer (2L) transmission capabilities (e.g., in response to a MIMO uplink grant).

As noted above, within the total resource limitation of the UE (e.g., the total number of RF chains available to the UE), UE 115 may be enabled to switch between different RF resource-sharing configurations based on various switching conditions. In aspects, the UE may determine whether one or more of the various switching conditions are present, and may determine an RF resource-configuration to select or to switch to, based on the presence of the one or more switching conditions. For example, UE 115 may be configured with two Tx chains, and, based on the presence of one or more switching conditions, may determine to select, or to switch to, a Dual Tx TDM configuration based on the presence of the one or more switching conditions. As noted above, the switching conditions may include a grant type provided to one or more of the multiple subscriptions, a priority of the service being performed by the different subscriptions, a procedure being performed by the different subscriptions, a change in the set of resources available to the UE, etc. Aspects of the functionality of UE 115 as described herein are discussed in more detail in the following.

FIG. 4 is a block diagram of an example wireless communications system 400 that supports mechanisms for flexible switching between different resource-sharing configurations of a multi-SIM communications device in a wireless communication system according to one or more aspects. In some examples, wireless communications system 400 may implement aspects of wireless network 100 and wireless network 300 described above. Wireless communications system 400 includes UE 115 and base stations 105a and 105b. Although one UE 115 and two base stations 105a and 105b are illustrated, in some implementations, wireless communications system 300 may generally include multiple UEs 115, and may include more than two base stations 105.

In aspects, UE 115 may be configured for multi-SIM communications. As such, UE 115 may be configured to subscribe to base station 105a and base station 105b each using a different SIM. In aspects, UE 115 may be configured with a set of RF resources, and may be configured with a plurality of different resource-sharing configurations for sharing the set of RF resources between the different SIM subscriptions. In particular, UE 115 may be configured to operate in DSDA mode, and both subscriptions of UE 115 may be in connected mode (e.g., RRC connected mode) with each of base station 105a and base station 105b. During this concurrency, UE 115 may communicate with both base station 105a and base station 105b via the respective subscription. This DSDA mode concurrency may be implemented using a resource-sharing configuration.

UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). Processor 402 may be configured to execute instructions stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store switching condition detection logic 405 and sharing configuration manager 406. In aspects, switching condition detection logic 405 may be configured to perform operations for determining whether one or more switching conditions are present. In aspects, the one or more switching conditions may be switching conditions of a plurality of switching conditions and may include a grant type provided to one or more of the multiple subscriptions, a priority of the service being performed by the different subscriptions, a procedure being performed by the different subscriptions, etc. In aspects, sharing configuration manager 406 may be configured to determine, based on the determination that the one or more switching conditions are present, a resource-sharing configuration to select or to switch to. In aspects, sharing configuration manager 406 may be configured to trigger the resource-sharing configuration switch, such as using a signaling based capability update and/or an autonomous capability update.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2.

Base stations 105a and 105b may be configured similarly. For example, base station 105a may include a variety of components (such as structural, hardware components) used for carrying out one or more functions described herein. For example, these components may include one or more processors 452a (hereinafter referred to collectively as “processor 452a”), one or more memory devices 454a (hereinafter referred to collectively as “memory 454a”), one or more transmitters 456a (hereinafter referred to collectively as “transmitter 456a”), and one or more receivers 458a (hereinafter referred to collectively as “receiver 458a”). Processor 452a may be configured to execute instructions stored in memory 454a to perform the operations described herein. In some implementations, processor 452a includes or corresponds to one or more of receive processor 238, transmit processor 220, and controller 240, and memory 454a includes or corresponds to memory 242. Base station 105b may include similar components (e.g., one or more processors 452b, one or more memory devices 454b, one or more transmitters 456b, and one or more receivers 458b).

Memory 454a includes or is configured to store resource sharing manager 460a. In aspects, resource sharing manager 460a may be configured to perform operations for managing and facilitating the flexible switching between resource-sharing configurations at UE 115 in accordance with aspects of the present disclosure. In particular, resource sharing manager 460a may be configured to receive assistance information from UE 115, the assistance information including information on preferred configuration or capabilities by UE 115 with respect to the SIM subscription connected to base station 105a, and resource sharing manager 460a may be configured to perform uplink scheduling in accordance with the assistance information. Resource sharing manager 460 of base station 105b may include similar functionality.

Transmitter 456a is configured to transmit reference signals, synchronization signals, control information and data to one or more other devices, and receiver 458a is configured to receive reference signals, control information and data from one or more other devices. For example, transmitter 456a may transmit signaling, control information and data to, and receiver 458a may receive signaling, control information and data from, UE 115. In some implementations, transmitter 456a and receiver 458a may be integrated in one or more transceivers. Additionally or alternatively, transmitter 456a or receiver 458a may include or correspond to one or more components of base station 105 described with reference to FIG. 2. Transmitter 456b and receiver 458b of base station 105b may include similar functionality.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP.

During operation of wireless communications system 400, UE 115 operates in a concurrent communication mode. In aspects, the concurrent communication mode may include a mode in which UE 115 may transmit, concurrently, over more than one subscriptions. For example, the concurrent communication mode may include a DSDA mode in which UE 115 may transmit to base station 105a over a first subscription and to base station 105b over a second subscription, concurrently, as described above.

In aspects, UE 115 may be configured with a plurality of resource-sharing configurations for sharing a set of resources of UE 115 between the first subscription and the second subscription during the concurrent communication mode. For example, UE 115 may be configured with a set of RF chains (e.g., Tx and/or Rx chains) available for communications. UE 115 may include a plurality of configurations for sharing the available RF chains between the plurality of SIMs configured to UE 115. In aspects, the plurality of resource-sharing configurations may include resource-sharing configurations as described in Table 1 above. During the concurrent communication mode, UE may select and use one or more of the plurality of resource-sharing configurations to enable the concurrent communication mode.

In aspects, UE 115 may select the resource-sharing configuration to use during the concurrent communication mode based on one or more conditions. The one or more conditions may include the switching conditions described below. Although the switching conditions below are described with reference to a determination to switch from a first resource-sharing configuration to a second resource-sharing configuration, in aspects, the switching conditions may also be used to select a resource-sharing configuration to use during the concurrent communication mode, even if the selected resource-sharing configuration is the initial resource-sharing configuration, rather than a resource-sharing configuration to which UE 115 is switching.

During operation of wireless communications system 400, UE 115 determines whether one or more switching conditions are present with respect to the concurrent communication mode. In aspects, the switching conditions may include a type of an uplink grant granted to UE 115 over one or more of the subscriptions. For example, UE 115 may be configured with two Tx chains, and may be operating in the single Tx full concurrency configuration. UE 115 may receive a two-layer (2L) uplink grant from base station 105a or from base station 105b. In this case, UE 115 may determine, based on the 2L uplink grant, that a switching condition is present with respect to the current concurrent communication mode. On the other hand, in this example, UE 115 instead receives a one-layer (1L) uplink grant from base station 105a or from base station 105b. In this case, UE 115 may determine, based on the 1L uplink grant, that this switching condition is not present with respect to the current concurrent communication mode. It is noted at this point that, as will be discussed below in more detail, the decision to switch to a different resource-configuration may be in favor of the higher level grant. For example, in this case, UE 115 may determine to switch to a resource-sharing configuration that provides more RF resources to the first subscription when the first subscription receives a 2L uplink grant, even at the cost of the second subscription, in the case that the second subscription has not received a high level uplink grant.

In aspects, the switching conditions may include a priority of the service being performed by the different subscriptions. For example, following the example above, UE 115 may determine that the first subscription (e.g., the subscription associated with base station 105a) may carry communications associated with a voice service. In this case, UE 115 may determine that a switching condition is present with respect to the current concurrent communication mode, as the voice service being provided by the first subscription is of a high priority. On the other hand, UE 115 may determine that the first subscription is carrying communications associated with a data service. In this case, UE 115 may determine that this particular switching condition is not present with respect to the current concurrent communication mode, as the data service being provided by the first subscription is not of a high priority. It is noted at this point that, as will be discussed below in more detail, the decision to switch to a different resource-configuration may be in favor of the high priority service. For example, in this case, UE 115 may determine to switch to a resource-sharing configuration that provides more RF resources to the first subscription when the first subscription is performing a high-priority service, even at the cost of the service being provided by the second subscription, in the case that the second subscription is not performing a high-priority service.

In aspects, the switching conditions may include a procedure being performed by the different subscriptions. For example, following the example above, UE 115 may determine that the first subscription is performing communications associated with a connection setup procedure. In this case, UE 115 may determine that a switching condition is present with respect to the current concurrent communication mode, as the connection setup procedure being performed by the first subscription is critical. On the other hand, UE 115 may determine that the first subscription is performing a procedure for maintaining a connection. In this case, UE 115 may determine that this particular switching condition is not present with respect to the current concurrent communication mode, as the connection maintenance procedure is not very critical. It is noted at this point that, as will be discussed below in more detail, the decision to switch to a different resource-configuration may be in favor of the more critical procedure. For example, in this case, UE 115 may determine to switch to a resource-sharing configuration that provides more RF resources to the first subscription when the first subscription is performing a connection setup procedure, even at the cost of the second subscription, in the case that the second subscription is not performing a critical procedure.

In aspects, the switching conditions may include a change in the set of resources available to the UE. For example, UE 115 may be configured with a set of resources, which UE 115 may share between the subscriptions during concurrency. In aspects, the set of resources configured to UE 115 may change (e.g., after a handover of UE 115 the set of resources available to UE 115 may change). For example, UE 115 may be configured with three Tx chains, but after the change UE 115 may be configured with two Tx chains. In this case, UE 115 may determine that this switching condition is present.

During operation of wireless communications system 400, UE 115 selects a resource-sharing configuration of the plurality of resource-sharing configurations based on a determination that the one or more switching conditions are present. In aspects, UE 115 may select a resource-sharing configuration based on the present switching conditions. For example, UE 115 may be configured with two Tx chains, and may be operating in the single Tx full concurrency configuration. UE 115 may determine that one or more switching conditions are present and based on that determination, UE 115 may select the dual Tx TDM configuration. In aspects, the selected resource-sharing configuration may depend on the switching condition present.

In aspects, UE 115 may trigger a switch from a first resource-sharing configuration to a second resource-sharing configuration. For example, in the case where UE 115 may be operating in the concurrent communication mode using a first resource-sharing configuration, and UE 115 may select a second resource-sharing configuration based on a determination that one or more switching conditions are present, UE 115 may trigger a switch from the first resource-sharing configuration to the second resource-sharing configuration.

It is noted that in wireless communication systems, each subscription of a UE may be configured to indicate a preferred uplink capability and/or configuration (e.g., one Tx chain, two Tx chains, etc.) to the network. In aspects, the flexible switching of resource-sharing configurations provided by aspects of the present disclosure enable protection of in-synced uplink transmissions of high priority messages, such as united air interface (UAI) messages to advice capability changes or critical signaling messages, before a UE's preferred uplink configurations my match the network uplink grant type. In this manner, even though the network uplink grant type may not match the preferred configuration of a subscription of a UE, the UE may be able to transmit the high priority messages using a preferred configuration thanks to the techniques provided herein.

In aspects, configuration of UE 115 to trigger the switch from a first resource-sharing configuration to a second resource-sharing configuration may include triggering the switch based on a capability update by one or more of the subscriptions. For example, each of the subscriptions may be configured to employ a signaling-based capability update and/or an autonomous capability update to trigger the switching from the first resource-sharing configuration to the second resource-sharing configuration.

In signaling-based capability update, UE 115 may transmit, over the first subscription, message 370 including assistance information to base station 105a. In alternative or additional aspects, UE 115 may transmit, over the second subscription, message 372 including assistance information to base station 105b. In aspects, the assistance information may include indications of transmission capabilities or preferences for transmission over the respective subscriptions. For example, the assistance information may include an RRC message (e.g., UEAssistanceInformation for maxMIMO-LayerPreference). In another example, the assistance information may include a non-access stratum (NAS) registration update with capability change. The assistance information message may cause a dynamic change of capabilities for the current connection over the respective subscription. For example, message 370 may cause a dynamic change of capabilities for the current connection over the first subscription, and/or message 372 may cause a dynamic change of capabilities for the current connection over the second subscription. The change of capabilities may cause the base station to provide uplink grants in accordance with the changed capabilities of the subscription.

In autonomous capability update, UE 115 may perform an autonomous downgrade over a subscription by physical layer signal control to trigger a network scheduling change. In aspects, UE 115 may perform the autonomous downgrade by lowering a transmission power of one or more reference signals over a subscription in one or more of the transmission ports available to the UE in order to trigger an uplink scheduling from the base station that includes a different number of layers, accordingly. For example, in aspects, UE 115 may lower a transmission power of an SRS transmission over a subscription on one or more Tx ports of UE 115, or may blank the SRS transmission over the one or more Tx ports, in order to cause the respective base station to change the uplink scheduling behavior. For example, UE 115 may be configured to transmit over a subscription with two Tx chains. UE 115 may lower the transmission power of an SRS transmission on one of the Tx chains, or may blank the SRS transmission over the one Tx chain, which may cause a base station (e.g., base station 105a or 105b) to schedule single layer grants for UE 115. In this manner, UE 115 may autonomously update the capabilities over a subscription during concurrent transmission mode.

In aspects, UE 115 may lower a transmission power of a DMRS transmission over a subscription on one or more Tx ports of UE 115, or may blank the DMRS transmission over the one or more Tx ports, in order to cause the respective base station to change the uplink scheduling behavior. For example, UE 115 may be configured to transmit over a subscription with two Tx chains. UE 115 may lower the transmission power of the DMRS transmission on one of the Tx chains, or may blank the DMRS transmission over the one Tx chain, which may cause a base station (e.g., base station 105a or 105b) to schedule single layer grants for UE 115. In this manner, UE 115 may autonomously update the capabilities over a subscription during concurrent transmission mode.

In aspects, UE 115 may report a fake non-zero BSR to request more PUSCH transmissions. The request for more PUSCH transmissions using the non-zero BSR causes the uplink grants to converge from MIMO uplink grants to SISO uplink grants. In this manner, UE 115 may autonomously update the capabilities over a subscription during concurrent transmission mode using the fake non-zero BSR.

In aspects, during the resource-sharing operation, the subscription receiving 1-layer PUSCH scheduling may use a single Tx chain to transmit the PUSCH during the concurrent communication mode (e.g., during a DSDA mode). Still, in aspects, such as for example when operating in DSDA mode with UE 115 configured with two Tx chains, UE 115 may implement a dual Tx TDM resource-sharing configuration for both DSDA subscriptions, such that, during the resource-sharing operation, both subscriptions may be allocated both Tx chains at different times, in a TDM manner, to enable transmission of important signaling transmissions before the network 1-layer PUSCH transmissions. In these implementations, a subscription with important or high-priority signaling to transmit may be referred to as a high-priority subscription. In this case, UE 115 may switch the two Tx chains between the two subscriptions to enable transmission of the important signaling. For example, where a first subscription is a normal-priority subscription and the second subscription is a high-priority subscription (or where the second priority subscription has a higher priority, such as when the signaling to be transmitted over the second subscription has a higher priority than the signaling to be transmitted over the first subscription), UE 115 may switch to a dual Tx TDM configuration so that two Tx chains are allocated to the second subscription, thereby taking a Tx chain from the normal-priority subscription. In aspects, the high-priority subscription may change to a normal-priority subscription once the important signaling transmission is completed.

In aspects, a determination that the transmission of the important signaling is completed may be based on a timer or may be based on feedback. For example, a timer may be used to determine when the important signaling transmission is completed over a subscription. For example, a timer may be activated and/or started upon a determination by UE 115 that important signaling is to be transmitted to a base station over a subscription. UE 115 may attempt to transmit the important signaling to the base station over a subscription, in accordance with aspects described herein. Upon expiration of the timer, UE 115 may stop attempting to transmit the important signaling to the base station over a subscription, if the important signaling transmission has not been completed upon expiration of the timer. In other aspects, feedback may be used to determine when the important signaling transmission is completed over a subscription. For example, UE 115 may receive an acknowledgement (ACK) feedback (e.g., a hybrid automatic repeat request (HARQ) ACK message) or a radio link control (RLC) ACK message indicating that the important signaling transmission was received successfully over the subscription. In this case, UE 115 may determine that the transmission of the important signaling is complete.

In aspects, the important signaling may include any combination of important signaling and control messages, such as RRC UEAssistanceInformation messages to notify a base station of MIMO capability changes, other RRC messages, such as RRC reconfiguration complete messages, measurement reports, etc., NAS signaling messages, IMS signaling messages, etc.

During operation of wireless communications system 400, UE 115 transmits data over the first subscription or the second subscription according to the selected resource-sharing configuration. For example, UE 115 may use the resource-sharing configuration selected by UE 115 to share the available RF resources between the first subscription and the second subscription and may transmit data 380 to base station 105a and/or data 382 to base station 105b over the shared RF resources in accordance with the selected resource-sharing configuration. In aspects, the resource-sharing configuration are as illustrated in Table 1 above.

FIG. 5 is a flow diagram illustrating an example of a wireless communication implementing flexible switching between different resource-sharing configurations of a multi-SIM communications device in a wireless communication system according to one or more aspects of the present disclosure. In aspects, the flow illustrated in FIG. 5 may be implemented in a wireless communication system, such as wireless communication system 400. In particular, wireless communications system 400 includes UE 115 and base stations 105a and 105b. In aspects, UE 115 may be configured for multi-SIM communications. As such, UE 115 may be configured to subscribe to base station 105a and base station 105b each using a different SIM. In aspects, UE 115 may be configured with a set of RF resources, and may be configured with a plurality of different resource-sharing configurations for sharing the set of RF resources between the different SIM subscriptions. In particular, UE 115 may be configured with at least two Tx chains and may be configured to operate in DSDA mode. In the DSDA mode, a first subscription of UE 115 may be in connected mode (e.g., RRC connected mode) with base station 105a using one of the Tx chains and a second subscription of UE 115 may be in connected mode (e.g., RRC connected mode) with base station 105b using the other Tx chain of UE 115. In this manner, UE 115 may be operating in single Tx full concurrency configuration. During the DSDA mode, UE 115 may operate to flexibly switch between different resource-sharing configurations in accordance with aspects of the present disclosure.

It is noted that control module 550, as illustrated in FIG. 5 may include one or more of the functionality of switching condition detection logic 405 and/or sharing configuration manager 406, as illustrated in and discussed with reference to FIG. 4.

As can be seen, UE 115 may determine that more RF resources may be needed by the second subscription. For example, UE 115 may determine that high-priority traffic (e.g., voice traffic, or traffic associated with a connection setup procedure, etc.) is to be transmitted to base station 105b using the second subscription, or that a MIMO uplink grant has been received from baser station 105b over the second subscription. In this case, a high-priority message request (HP Msg Req) may be sent to control module 550 in order to notify control module 550 that more RF sources are desired by the second subscription. Indeed, at this point the second subscription is allocated a single Tx chain, and a PUSCH transmission (1. Tx PUSCH) may be transmitted over the second subscription to base station 105b using the single Tx chain before the two Tx chains are allocated to the second subscription. As the grant to the second subscription is a MIMO grant, the base station 105b may respond to the second subscription with an negative ACK feedback (NACK) because the PUSCH transmission was over a single layer transmission, instead of the MIMO transmission.

Control module 550 may request (dual Tx TDM req), from the first subscription, a switch to the dual Tx TDM configuration, as the first subscription may be allocated one of the two available Tx chains. Indeed, a PUSCH transmission (1. Tx PUSCH) may be transmitted over the first subscription to base station 105a using the Tx chain allocated to the first subscription before the dual Tx TDM configuration change request is confirmed by the first subscription. The first subscription may confirm the dual Tx TDM configuration change request to control module 550 (dual Tx TDM conf), and control module 550 may respond to the second subscription with a high-priority message response (HP Msg Resp). UE 115 may then switch to the dual Tx TDM configuration, and may grant two Tx chains (2. Tx grant) to the second subscription. This may leave the first subscription with no Tx chains allocated to it (no Tx).

With both Tx chains allocated to the second subscription, important signaling may be transmitted in a high-priority message (HP Msgs) to base station 105b using the two Tx chains. During this time, no transmission (No Tx) are performed over the first subscription. However, UE 115 may determine to switch the allocation of the two Tx chains and transfer the allocation of the two Tx chains to the first subscription (2. Tx grant). At this time, the first subscription may transmit using the two Tx chains (2. Tx), such as an uplink transmission (2. Tx uplink) to base station 105a, while no transmissions (No Tx) are performed over the second subscription.

UE may determine to switch back the allocation of the two Tx chains and transfer the allocation of the two Tx chains to the second subscription (2. Tx grant). At this time, the second subscription may transmit a PUSCH (2. Tx PUSCH) using the two Tx chains (2. Tx). As this PUSCH transmission is in response to a MIMO grant, and as the PUSCH transmission is transmitted using two Tx chains, base station 105b may send an ACK feedback message to the second subscription. At this time, base station 105b may change the uplink scheduling to cease granting MIMO grants to the second subscription, and may begin granting SISO grants to the second subscription instead.

UE 115 may determine that the transmission of the high-priority messages, or that the condition determined to indicate that more resources were needed by the second subscription, has ended or is completed. Based on this determination, the second subscription may request to be downgraded to a normal-priority subscription by sending a normal-priority message request (NP Msg Req) to control module 550. In response to the normal-priority message request from the second subscription, and UE 115 may switch back to single Tx full concurrency configuration. In the single Tx full concurrency configuration, control module 550 may allocate a single Tx chain (Single Tx Grant) to the second subscription and a single Tx chain (1Tx Grant) to the first subscription. In aspects, control module 550 may send a response (NP Resp) to the normal-priority message request to the second subscription. The first subscription may then be enabled to transmit a PUSCH (1. Tx PUSCH) to base station 105a using the single Tx chain allocated to it, and the second subscription may also be enabled to transmit a PUSCH (1. Tx PUSCH) to base station 105a using the single Tx chain allocated to it. In aspects, base station 105b may reply with an ACK, as the PUSCH transmission is in response to a SISO grant.

In aspects, the determination that the transmission of the high-priority messages, or the condition determined to indicate that more resources were needed by the second subscription, has ended or been completed may be based on a timer. For example, a timer may have been started upon the determination by UE 115 that more RF resources may be needed by the second subscription. In this case, upon expiration of the timer, even if no ACK has been received from base station 105b for the MIMO uplink grants, UE 115 may switch the second subscription back to normal-priority subscription, and may switch back to single Tx full concurrency configuration.

In this manner, UE 115 may be enabled to flexibly switch between resource-sharing configurations, as well as flexibly switch the allocations of the RF resources between the different SIMs based on various conditions.

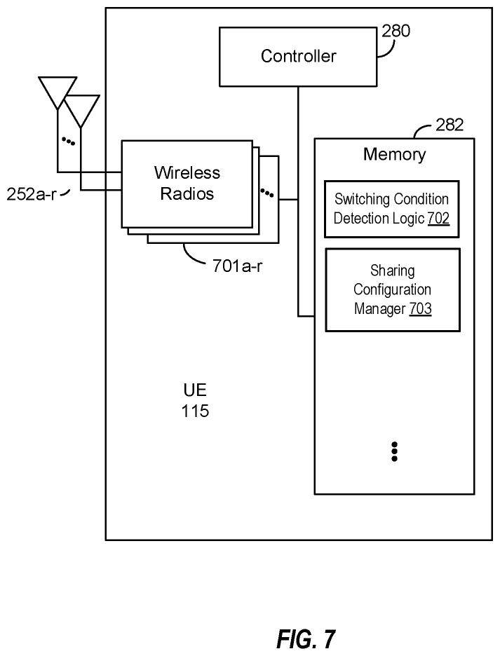

FIG. 6 is a flow diagram illustrating an example process 600 that supports mechanisms for flexible switching between different resource-sharing configurations of a multi-SIM communications device in a wireless communication system according to one or more aspects. Operations of process 600 may be performed by a UE, such as UE 115 described above with reference to FIGS. 1-5, or a UE described with reference to FIG. 7. For example, example operations (also referred to as “blocks”) of process 600 may enable UE 115 to support mechanisms for flexible switching between different resource-sharing configurations of a multi-SIM communications device. FIG. 7 is a block diagram of an example UE 115 that supports mechanisms for flexible switching between different resource-sharing configurations of a multi-SIM communications device in a wireless communication system according to one or more aspects. UE 115 may be configured to perform operations, including the blocks of a process described with reference to FIG. 6. In some implementations, UE 115 includes the structure, hardware, and components shown and described with reference to UE 115 of FIGS. 1-4. For example, UE 115 includes controller 280, which operates to execute logic or computer instructions stored in memory 282, as well as controlling the components of UE 115 that provide the features and functionality of UE 115. UE 115, under control of controller 280, transmits and receives signals via wireless radios 701a-r and antennas 252a-r. Wireless radios 701a-r include various components and hardware, as illustrated in FIG. 2 for UE 115, including modulator and demodulators 254a-r, MIMO detector 256, receive processor 258, transmit processor 264, and TX MIMO processor 266.

In block 602, the UE (e.g., UE 115) operates in a concurrent communication mode. In aspects, the UE may be configured for multi-SIM communications including a first subscription and a second subscription, and may be configured with a plurality of resource-sharing configurations for sharing a set of resources available to the UE between the first subscription and the second subscription during the concurrent communication mode. In order to implement the functionality for such operations, UE 115, under control of controller/processor 280, sharing configuration manager 703, stored in memory 282. The functionality implemented through the execution environment of sharing configuration manager 703 allows for UE 115 to perform operations to operate in a concurrent communication mode according to the various aspects herein. In aspects, UE 115 may perform operations to operate in a concurrent communication mode according to operations and functionality as described above with reference to UE 115 and as illustrated in FIGS. 1-5.

In block 604, the UE (e.g., UE 115) determines whether one or more switching conditions are present with respect to the concurrent communication mode. In order to implement the functionality for such operations, UE 115, under control of controller/processor 280, switching condition detection logic 702, stored in memory 282. The functionality implemented through the execution environment of switching condition detection logic 702 allows for UE 115 to perform operations to determine whether one or more switching conditions are present with respect to the concurrent communication mode according to the various aspects herein. In aspects, UE 115 may perform operations to determine whether one or more switching conditions are present with respect to the concurrent communication mode according to operations and functionality as described above with reference to UE 115 and as illustrated in FIGS. 1-5.

In block 606, the UE (e.g., UE 115) selects a resource-sharing configuration of the plurality of resource-sharing configurations based on a determination that the one or more switching conditions are present. In order to implement the functionality for such operations, UE 115, under control of controller/processor 280, sharing configuration manager 703, stored in memory 282. The functionality implemented through the execution environment of sharing configuration manager 703 allows for UE 115 to perform operations to select a resource-sharing configuration of the plurality of resource-sharing configurations based on a determination that the one or more switching conditions are present according to the various aspects herein. In aspects, UE 115 may perform operations to select a resource-sharing configuration of the plurality of resource-sharing configurations based on a determination that the one or more switching conditions are present according to operations and functionality as described above with reference to UE 115 and as illustrated in FIGS. 1-5.

In block 608, the UE (e.g., UE 115) transmits data over at least one of the first subscription or the second subscription based on the selected resource-sharing configuration. In order to implement the functionality for such operations, UE 115, under control of controller/processor 280, transmits data over at least one of the first subscription or the second subscription based on the selected resource-sharing configuration via wireless radios 601a-r and antennas 252a-r. In aspects, UE 115 may perform operations to transmit data over at least one of the first subscription or the second subscription based on the selected resource-sharing configuration according to operations and functionality as described above with reference to transmitting UE 115 and as illustrated in FIGS. 1-5.

In one or more aspects, techniques for supporting mechanisms for flexible switching between different resource-sharing configurations of a multi-SIM communications device in a wireless communication system according to one or more aspects may include additional aspects, such as any single aspect or any combination of aspects described below or in connection with one or more other processes or devices described elsewhere herein. In a first aspect, supporting mechanisms for flexible switching between different resource-sharing configurations of a multi-SIM communications device may include an apparatus configured to operate in a concurrent communication mode. The apparatus may be configured for multi-SIM communications including a first subscription and a second subscription, and may be configured with a plurality of resource-sharing configurations for sharing a set of resources available to the apparatus between the first subscription and the second subscription during the concurrent communication mode. The apparatus may also be configured to determine whether one or more switching conditions are present with respect to the concurrent communication mode, to select a resource-sharing configuration of the plurality of resource-sharing configurations based on a determination that the one or more switching conditions are present, and to transmit data over at least one of the first subscription or the second subscription based on the selected resource-sharing configuration. Additionally, the apparatus may perform or operate according to one or more aspects as described below. In some implementations, the apparatus includes a wireless device, such as a UE (e.g., transmitting UE 115a as described above). In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, alone or in combination with the first aspect, the UE is currently operating, prior to the transmitting, in a first resource-sharing configuration.

In a third aspect, alone or in combination with one or more of the first aspect or the second aspect, the techniques of the first aspect includes triggering a switch from the first resource-sharing configuration to the selected resource-sharing configuration.

In a fourth aspect, alone or in combination with one or more of the first aspect through the third aspect, triggering the switch includes transmitting, to one or more network entities a signal including an indication of a preferred configuration for a connection for one or more of the first subscription or second subscription.

In a fifth aspect, alone or in combination with the fourth aspect, the indication causes the one or more network entities to update capabilities of a current connection with the one or more of the first subscription or second subscription.

In a sixth aspect, alone or in combination with one or more of the first aspect through the fifth aspect, triggering the switch includes performing an autonomous downgrade of capabilities by one or more of the first subscription or second subscription to trigger a scheduling change with respect to the one or more of the first subscription or second subscription by one or more network entities.

In a seventh aspect, alone or in combination with one or more of the first aspect through the sixth aspect, performing the autonomous downgrade includes lowering a transmission power of one or more reference signals transmitted over the one or more of the first subscription or the second subscription in one or more transmission port available to the UE to trigger the scheduling change by the one or more network entities.

In an eighth aspect, alone or in combination with the seventh aspect, performing the autonomous downgrade includes transmitting a non-zero BSR to request additional grants for uplink transmissions.

In a ninth aspect, alone or in combination with one or more of the first aspect through the eighth aspect, the one or more switching conditions include a grant type of an uplink transmission granted to one or more of the first subscription or the second subscription.

In a tenth aspect, alone or in combination with the ninth aspect, the one or more switching conditions include a priority of traffic associated with a service being performed by the one or more of the first subscription or the second subscription.

In an eleventh aspect, alone or in combination with one or more of the ninth aspect through the tenth aspect, the one or more switching conditions include a type of procedure being performed by the one or more of the first subscription or the second subscription.

In a twelfth aspect, alone or in combination with one or more of the ninth aspect through the eleventh aspect, the one or more switching conditions include a change in the set of resources available to the UE.

In a thirteenth aspect, alone or in combination with one or more of the first aspect through the twelfth aspect, the grant type of the uplink transmission is based on the number of layers of the granted uplink transmission.

In a fourteenth aspect, alone or in combination with the thirteenth aspect, a higher number of layers indicates a higher priority.

In a fifteenth aspect, alone or in combination with one or more of the first aspect through the fourteenth aspect, the priority of the traffic associated with the service being performed is based on the priority of the service being provided.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
operating, by the UE, in a concurrent communication mode, wherein the UE is configured for multi-subscriber identity module (SIM) communications including a first subscription and a second subscription, wherein the UE is configured with a plurality of resource-sharing configurations for sharing a set of resources available to the UE between the first subscription and the second subscription during the concurrent communication mode;
determining, by the UE, whether one or more switching conditions are present with respect to the concurrent communication mode;
selecting a resource-sharing configuration of the plurality of resource-sharing configurations based on a determination that the one or more switching conditions are present; and
transmitting data over at least one of the first subscription or the second subscription based on the selected resource-sharing configuration.

2. The method of claim 1, wherein the UE is currently operating, prior to the transmitting, in a first resource-sharing configuration, and further comprising:
triggering a switch from the first resource-sharing configuration to the selected resource-sharing configuration.

3. The method of claim 2, wherein triggering the switch includes:
transmitting, to one or more network entities a signal including an indication of a preferred configuration for a connection for one or more of the first subscription or second subscription, wherein the indication causes the one or more network entities to update capabilities of a current connection with the one or more of the first subscription or second subscription.

4. The method of claim 2, wherein triggering the switch includes:
performing an autonomous downgrade of capabilities by one or more of the first subscription or second subscription to trigger a scheduling change with respect to the one or more of the first subscription or second subscription by one or more network entities.

5. The method of claim 4, wherein performing the autonomous downgrade includes one or more of:
lowering a transmission power of one or more reference signals transmitted over the one or more of the first subscription or the second subscription in one or more transmission port available to the UE to trigger the scheduling change by the one or more network entities; or
transmitting a non-zero buffer status report (BSR) to request additional grants for uplink transmissions.

6. The method of claim 1, wherein the one or more switching conditions include one or more of:
a grant type of an uplink transmission granted to one or more of the first subscription or the second subscription;
a priority of traffic associated with a service being performed by the one or more of the first subscription or the second subscription;
a type of procedure being performed by the one or more of the first subscription or the second subscription; or
a change in the set of resources available to the UE.

7. The method of claim 6, wherein the grant type of the uplink transmission is based on the number of layers of the granted uplink transmission, wherein a higher number of layers indicates a higher priority.

8. The method of claim 6, wherein the priority of the traffic associated with the service being performed is based on the priority of the service being provided.

9. A user equipment (UE) comprising:
at least one processor; and
a memory coupled with the at least one processor and storing processor-readable code that, when executed by the at least one processor, is configured to perform operations including:
operating, by the UE, in a concurrent communication mode, wherein the UE is configured for multi-subscriber identity module (SIM) communications including a first subscription and a second subscription, wherein the UE is configured with a plurality of resource-sharing configurations for sharing a set of resources available to the UE between the first subscription and the second subscription during the concurrent communication mode;
determining, by the UE, whether one or more switching conditions are present with respect to the concurrent communication mode;
selecting a resource-sharing configuration of the plurality of resource-sharing configurations based on a determination that the one or more switching conditions are present; and
transmitting data over at least one of the first subscription or the second subscription based on the selected resource-sharing configuration.

10. The UE of claim 9, wherein the UE is currently operating, prior to the transmitting, in a first resource-sharing configuration, and wherein the operations further include:
triggering a switch from the first resource-sharing configuration to the selected resource-sharing configuration.

11. The UE of claim 10, wherein triggering the switch includes:
transmitting, to one or more network entities a signal including an indication of a preferred configuration for a connection for one or more of the first subscription or second subscription, wherein the indication causes the one or more network entities to update capabilities of a current connection with the one or more of the first subscription or second subscription.

12. The UE of claim 10, wherein triggering the switch includes:
performing an autonomous downgrade of capabilities by one or more of the first subscription or second subscription to trigger a scheduling change with respect to the one or more of the first subscription or second subscription by one or more network entities.

13. The UE of claim 12, wherein performing the autonomous downgrade includes one or more of:
lowering a transmission power of one or more reference signals transmitted over the one or more of the first subscription or the second subscription in one or more transmission port available to the UE to trigger the scheduling change by the one or more network entities; or
transmitting a non-zero buffer status report (BSR) to request additional grants for uplink transmissions.

14. The UE of claim 9, wherein the one or more switching conditions include one or more of:
a grant type of an uplink transmission granted to one or more of the first subscription or the second subscription;
a priority of traffic associated with a service being performed by the one or more of the first subscription or the second subscription;
a type of procedure being performed by the one or more of the first subscription or the second subscription; or
a change in the set of resources available to the UE.

15. The UE of claim 14, wherein the grant type of the uplink transmission is based on the number of layers of the granted uplink transmission, wherein a higher number of layers indicates a higher priority.

16. The UE of claim 14, wherein the priority of the traffic associated with the service being performed is based on the priority of the service being provided.

17. A non-transitory computer-readable medium storing instructions that, when executed by a processor, cause the processor to perform operations comprising:
operating, by a user equipment (UE), in a concurrent communication mode, wherein the UE is configured for multi-subscriber identity module (SIM) communications including a first subscription and a second subscription, wherein the UE is configured with a plurality of resource-sharing configurations for sharing a set of resources available to the UE between the first subscription and the second subscription during the concurrent communication mode;
determining, by the UE, whether one or more switching conditions are present with respect to the concurrent communication mode;
selecting a resource-sharing configuration of the plurality of resource-sharing configurations based on a determination that the one or more switching conditions are present; and
transmitting data over at least one of the first subscription or the second subscription based on the selected resource-sharing configuration.

18. The non-transitory computer-readable medium of claim 17, wherein the UE is currently operating, prior to the transmitting, in a first resource-sharing configuration, and wherein the operations further include:
triggering a switch from the first resource-sharing configuration to the selected resource-sharing configuration.

19. The non-transitory computer-readable medium of claim 18, wherein triggering the switch includes one or more of:
transmitting, to one or more network entities a signal including an indication of a preferred configuration for a connection for one or more of the first subscription or second subscription, wherein the indication causes the one or more network entities to update capabilities of a current connection with the one or more of the first subscription or second subscription; or
performing an autonomous downgrade of capabilities by one or more of the first subscription or second subscription to trigger a scheduling change with respect to the one or more of the first subscription or second subscription by one or more network entities.

20. The non-transitory computer-readable medium of claim 17, wherein the one or more switching conditions include one or more of:
a grant type of an uplink transmission granted to one or more of the first subscription or the second subscription;
a priority of traffic associated with a service being performed by the one or more of the first subscription or the second subscription;
a type of procedure being performed by the one or more of the first subscription or the second subscription; or
a change in the set of resources available to the UE.
